(19) United States
(12) Patent Application Publication
(10) Pub. No.: US 2016/0087850 A1
(43) Pub. Date: Mar. 24, 2016

(54) MANAGEMENT APPARATUS, COMMUNICATION APPARATUS, MANAGEMENT SYSTEM, MANAGEMENT METHOD, AND COMPUTER PROGRAM PRODUCT

(71) Applicant: Kabushiki Kaisha Toshiba, Minato-ku (JP)

(72) Inventors: Yusuke DOI, Yokohama (JP); Yoshihiro OBA, Kawasaki (JP); Daisuke AJITOMI, Setagaya (JP); Hiroshi KAWAZOE, Kawasaki (JP); Keisuke MINAMI, Kawasaki (JP)

(73) Assignee: Kabushiki Kaisha Toshiba, Minato-ku (JP)

(21) Appl. No.: 14/824,436

(22) Filed: Aug. 12, 2015

(30) Foreign Application Priority Data
Sep. 19, 2014 (JP) 2014-191572

(51) Int. Cl. H04L 12/24; H04L 12/751

(52) U.S. Cl. CPC H04L 41/12; H04L 45/02

(57) ABSTRACT

According to an embodiment, a management apparatus includes a receiver, a first calculator, and a second calculator. The receiver is configured to receive existence information from communication apparatuses, the information probabilistically indicating characteristics of identification information of other communication apparatuses detected by a corresponding communication apparatus. The first calculator is configured to calculate, for each communication apparatus, some of the identification information, as a first set indicating a set of other communication apparatuses detectable by the communication apparatuse. The second calculator is configured to calculate, for each communication apparatus, a second set with a smaller number of false positives than the corresponding first set, as existence probability information, based on the existence information and the first set. The existence probability information indicates a probability of existence of a link between the communication apparatus and the other communication apparatus.

### CROSS-REFERENCE TO RELATED APPLICATION

This application is based upon and claims the benefit of priority from Japanese Patent Application No. 2014-191572, filed on Sep. 19, 2014; the entire contents of which are incorporated herein by reference.

### FIELD

Embodiments described herein relate generally to a management apparatus, a communication apparatus, a management system, a management method, and a computer program product.

### BACKGROUND

In IPv6 Routing Protocol for Low power and Lossy Networks (RPL) serving as a routing protocol, it is known that a network is represented by a destination oriented directed acyclic graph (DODAG).

In addition, there is disclosed a method of broadcasting a route response that stores route information to adjacent nodes in a multi-hop network.

However, the DODAG can have a plurality of upward links to nodes closer to a data aggregation point (DAP). However, for links other than the upward links, particularly, sibling links, information is discarded. Hence, there is limited information to be used for network analysis. In addition, to store route information in a route response, the number of bits whose quantity is proportional to the amount of information is required for each node. Accordingly, information used for structure analysis cannot be efficiently collected.

### BRIEF DESCRIPTION OF THE DRAWINGS

FIG. 1 is a schematic diagram of a management system;

FIG. 2 is an illustrative diagram of a Bloom filter;

FIG. 3 is a diagram illustrating an example of a DODAG;

FIG. 4 is a schematic diagram illustrating an example of a relationship between a first set and a second set;

FIG. 5 is a flowchart illustrating an example of a procedure of a communication process;

FIG. 6 is a flowchart illustrating a procedure of a management process;

FIG. 7 is a schematic diagram of a management system;

FIG. 8 is an illustrative diagram of the installation location of a detection apparatus;

FIG. 9 is a flowchart illustrating a procedure of a management process; and

FIG. 10 is a block diagram illustrating an exemplary hardware configuration.

### DETAILED DESCRIPTION

According to an embodiment, a management apparatus includes a receiver, a first calculator, and a second calculator. The receiver is configured to receive pieces of existence information from a plurality of communication apparatuses, respectively. Each piece of existence information probabilistically indicates characteristics of pieces of identification information of other communication apparatuses detected by a corresponding communication apparatus. The first calculator is configured to calculate, for each of the plurality of communication apparatuses, at least one of the pieces of identification information, as a first set indicating a set of other communication apparatuses detectable by the each of the plurality of communication apparatuses. The second calculator is configured to calculate, for each of the plurality of communication apparatuses, a second set with a smaller number of false positives than the corresponding first set, as a piece of existence probability information, based on the piece of existence information received from the each of the plurality of communication apparatuses and the corresponding first set. The piece of existence probability information indicates a probability of existence of a link between the each of the plurality of communication apparatuses and each of the other communication apparatuses.

Embodiments of a management apparatus, a communication apparatus, a management system, a management method, and a program will be described in detail below with reference to the accompanying drawings.

### First Embodiment

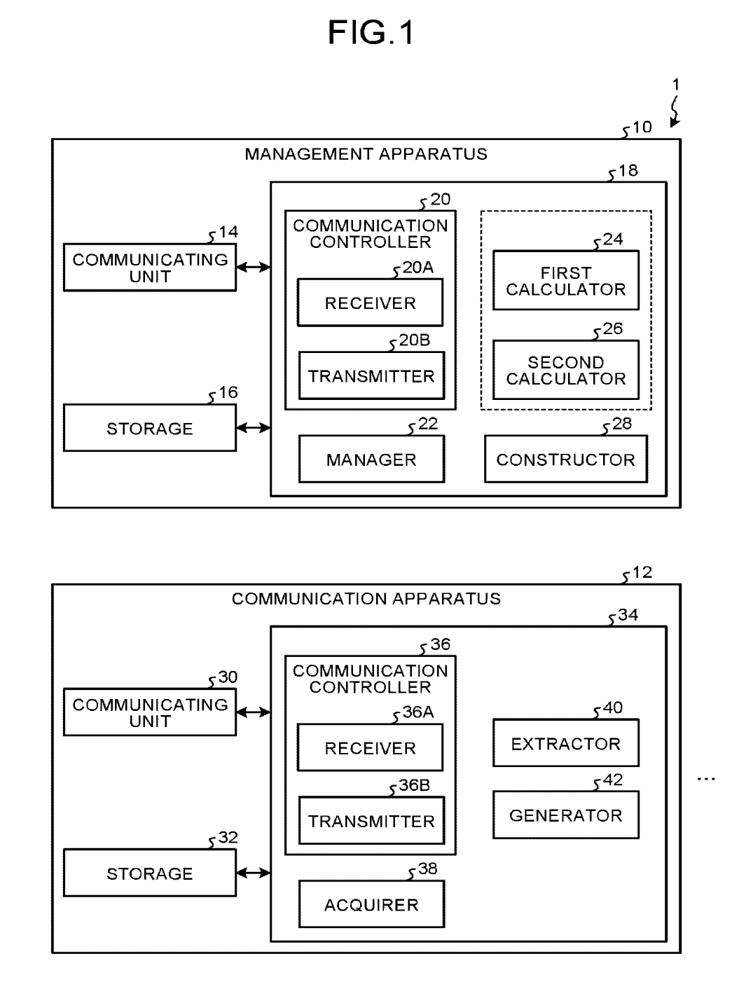

FIG. 1 is a schematic diagram of a management system 1. The management system 1 includes a management apparatus 10 and a plurality of communication apparatuses 12.

The management apparatus 10 calculates, for each of the plurality of communication apparatuses 12, existence probability information indicating the probability of the existence of a link between each of the plurality of communication apparatuses 12 and each of other communication apparatuses 12 for each of the plurality of communication apparatuses 12 (details will be described later). The existence probability information is used, for example, for structure analysis of a network including the plurality of communication apparatuses 12.

The communication apparatuses 12 are apparatuses having at least the function of transmitting various types of data and signals. The communication apparatuses 12 are, for example, publicly known personal computers.

The management apparatus 10 and each of the plurality of communication apparatuses 12 can perform communication or reception with each other by communicating units which will be described later. Note that, in the following, communication (i.e., transmission and reception) and reception may be collectively and simply referred to as “communication”.

The management apparatus 10 and each of the plurality of communication apparatuses 12 may be able to perform direct communication with each other or may be able to perform relay communication (multi-hop communication) with each other. Communication between the management apparatus 10 and each of the communication apparatuses 12 can use publicly known techniques such as TCP/IP, IPv6 over Low power Wireless Personal Area Networks (6LoWPAN), IPv6 Routing Protocol for Low power and Lossy Networks (RPL), and 802.15.4.

First, the communication apparatuses 12 will be described.

Each communication apparatus 12 includes a communicating unit 30, a storage 32, and a controller 34. The communicating unit 30 and the storage 32 are connected to the controller 34.

The communicating unit 30 is a publicly known communication device for performing wireless or wired communication with the management apparatus 10 and other communication apparatuses 12. Note that the communicating unit 30 may be a communication device capable of receiving data and signals from other communication apparatuses 12 wirelessly or by wire. The storage 32 stores various types of data.

The controller 34 is a computer configured to include a central processing unit (CPU), etc. Note that the controller 34 may be a circuit other than a CPU, etc.

The controller 34 includes a communication controller 36, an acquirer 38, an extractor 40, and a generator 42, the communication controller 36 includes a receiver 36A and a transmitter 36B.

Some or all of the communication controller 36, the receiver 36A, the transmitter 36B, the acquirer 38, the extractor 40, and the generator 42 may be implemented by, for example, causing a processing apparatus such as a CPU to execute a program, i.e., by software, or may be implemented by hardware such as an integrated circuit (IC), or may be implemented by using both software and hardware.

The communication controller 36 controls communication with each of a plurality of other communication apparatuses 12 through the communicating unit 30. Note that the communication controller 36 may control reception from at least one of the plurality of other communication apparatuses 12.

In the present embodiment, the communication controller 36 has a communication function required for a mesh network. The communication controller 36 uses, for example, publicly known techniques such as RPL.

The communication controller 36 detects other communication apparatuses 12 that are detectable by the communication apparatus 12 where the communication controller 36 is mounted. The term “detectable” refers to that data or signals are receivable or data or signals are communicable.

The communication controller 36 includes the receiver 36A and the transmitter 36B. The receiver 36A receives various types of data or signals from each of the plurality of other communication apparatuses 12.

In the present embodiment, the receiver 36A receives, through the communicating unit 30, identification information of other communication apparatuses 12 wirelessly or by wire, with which the communication apparatus 12 can perform direct (i.e., one-to-one) data communication or data reception.

Specifically, the receiver 36A receives identification information of other communication apparatuses 12 with which the communication apparatus 12 can perform direct communication or direct signal reception, from the other communication apparatuses 12. The receiver 36A may receive identification information of other communication apparatuses 12 by reading response signals to communication request signals which are transmitted to the other communication apparatuses 12 by the transmitter 36B. Alternatively, the receiver 36A may receive identification information of other communication apparatuses 12 by receiving signals including the identification information which are sent from the other communication apparatuses 12 irrespective of communication request signals.

The identification information of a communication apparatus 12 is information uniquely identifying the communication apparatus 12. The identification information of the communication apparatus 12 is, for example, a MAC address which is provided in advance to the communicating unit 30 provided in each communication apparatus 12, a communication node, or the like, but is not limited thereto.

The acquirer 38 obtains, from detectable other communication apparatuses 12, identification information of the other communication apparatuses 12. The acquirer 38 obtains identification information of detectable other communication apparatuses 12 by obtaining identification information of other communication apparatuses 12 received by the communication controller 36.

The acquirer 38 sequentially stores, in the storage 32, the acquired pieces of identification information of the communication apparatuses 12 and the detected dates and times (i.e., received dates and times) of the acquired pieces of identification information in association with each other. In addition, the acquirer 38 may store the pieces of identification information of the communication apparatuses 12, the detected dates and times, and wireless qualities in association with one another. The wireless qualities may be acquired from the communication controller 36. The wireless qualities are, for example, received signal strength indicators (RSSIs).

The extractor 40 extracts at least some of a plurality of pieces of identification information acquired in the past.

In the present embodiment, the extractor 40, for example, deletes those pieces of identification information that have not been detected over a predetermined period of time, among a plurality of pieces of identification information stored in the storage 32. A threshold value of the period of time for the deletion may be, for example, set in advance based on the interval of beacon transmission by the communicating unit 30, etc. Then, the extractor 40 extracts a list of pieces of identification information stored in the storage 32.

Note that the extractor 40 may extract from the storage 32 pieces of identification information that are detected within a predetermined period of time from the present time to the past. The predetermined period of time is the same as the threshold value of the period of time for the deletion.

In addition, the extractor 40 may extract from the storage 32 identification information with a wireless quality greater than or equal to a predetermined threshold value. In addition, the extractor 40 may extract from the storage 32 identification information that is detected within a predetermined period of time and that is greater than or equal to a predetermined threshold value. A threshold value of the wireless quality may be set in advance.

The generator 42 generates existence information that probabilistically indicates the characteristics of the pieces of identification information acquired by the acquirer 38. Note that the existence information may have a predetermined fixed length or may have a variable length. For example, the length of the existence information corresponds to the number (second number) of hash functions which will be described later.

It is preferred that the generator 42 generate existence information indicating, in a predetermined fixed length, the characteristics of pieces of identification information extracted by the extractor 40 among pieces of identification information acquired by the acquirer 38.

The existence information is not identification information itself, but is information that represents, by fixed-length bits, the characteristics of pieces of identification information, using statistical properties. The present embodiment describes the case in which the existence information is a Bloom filter that represents the characteristics of pieces of identification information by a bit pattern with bit positions corresponding to hash values. Note that the existence information is not limited to the Bloom filter.

In the present embodiment, the generator 42 generates a Bloom filter every predetermined period of time, using a plurality of pieces of identification information extracted by the extractor 40.

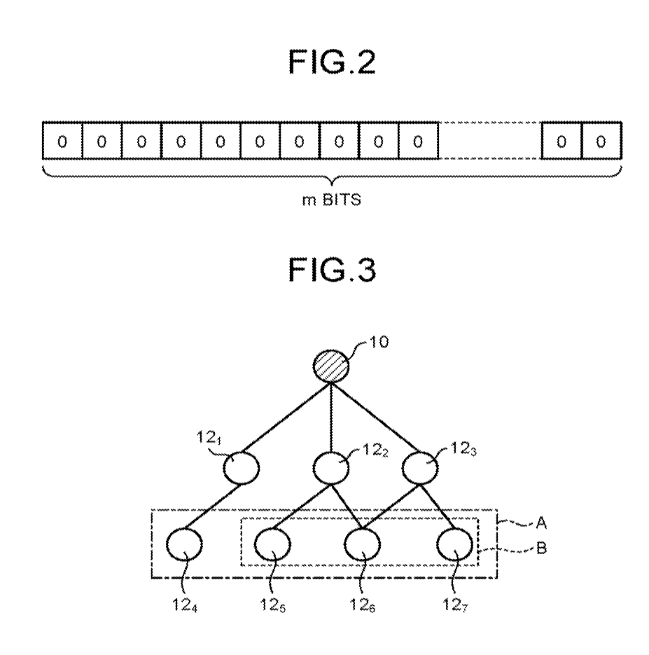

FIG. 2 is an illustrative diagram of a summary of a Bloom filter. As illustrated in FIG. 2, an empty Bloom filter is a bit pattern of m bits where the bit values at the respective bit positions are all set to “0”. The Bloom filter has, as parameters, the number of bits (m bits (m is an integer greater than or equal to 2)) in the Bloom filter and k hash functions.

In the present embodiment, every time existence information is generated, the generator 42 calculates a first number of pieces of identification information used to generate the existence information; the number of bits m indicating the data length of the existence information; hash functions; and a second number (k) of the hash functions. Then, the generator 42 generates existence information using pieces of identification information whose number is the first number among the pieces of identification information, the number of bits m, and k hash functions.

Hence, the generator 42 calculates, before generating existence information, parameters used for the generation and generates existence information using the calculated parameters.

The generator 42 first reads a plurality of pieces of identification information extracted by the extractor 40, as a key set S₀ for generation of a Bloom filter.

In addition, the generator 42 reads a shared variable X which is predetermined with the management apparatus 10. For the shared variable X, for example, the time of generation of a Bloom filter, the version of an RPL destination-oriented directed acyclic graph, or the like, is used.

Then, the generator 42 performs set aggregation such that the number of the pieces of identification information included in the key set S₀ is the first number. Note that the generator 42 may be configured not to perform set aggregation.

Specifically, the generator 42 computes, by the following Equation (2), an expected value of saturation “a” of a Bloom filter with a bit length m, for when the first number n is represented by the following Equation (1):

n=|S₀| (1)

a=1−(1/m)^{n-k} (2)

Note that in Equation (2) k represents the number (the second number) of hash functions.

Then, when the saturation “a” exceeds a predetermined threshold value a_{T} of the saturation, the generator 42 sets a number obtained by subtracting “1” from the number of bits m which is (m−1), as the new number of bits m.

In addition, the generator 42 sets the first number n which is the number of pieces of identification information, to the value of 1/r. Note that r is the number of repetitions of a set constrain, which has an initial value of “1” and which is incremented by a value of “1” every time a set constrain is repeated.

The generator 42 repeats the set constraint until the saturation “a” falls below the threshold value a_{T}. Then, when the first number n which is the number of pieces of identification information matches the value of 1/r, the generator 42 selects, based on the shared variable X, pieces of identification information whose number is 1/r (i.e., the first number) from the pieces of identification information extracted by the extractor 40.

For example, the generator 42 selects identification information whose remainder of the division of its hash value by r matches the remainder of the division of the shared variable X by r, among the plurality of pieces of identification information extracted by the extractor 40.

Note that, specifically, a set S⊂S₀ used for generation of a Bloom filter is calculated using, for example, the following Equation (3), with the number of repetitions of a set constraint being r:

S={s|sεS₀ and hash(s)%r=X%r} (3)

In Equation (3), hash(s) is any hash function and % is the modulo operator.

Note that the generator 42 may be configured not to perform a set constraint. In this case, the generator 42 treats S=S₀.

Then, the generator 42 initializes a Bloom filter generated last time. Specifically, the generator 42 prepares a bit array B with a length equal to the number of bits m, and sets all of the bit values at the respective bit positions to “0”, and thereby initializing. Note that in the present embodiment each bit position in a Bloom filter is represented by B[i], using an index i. Note that the index i is a value between 0 and m−1, inclusive.

Then, the generator 42 generates a Bloom filter.

The generator 42 computes hash values h_{k′}(s+X) using k hash functions, for each element s where sεS (i.e., each piece of identification information extracted and subject to set aggregation, as appropriate). k′ is an integer between 1 and k (second number), inclusive. Then, the generator 42 sets the bit value at a bit position with the index i corresponding to the hash value (i.e., B[h_{k′}(s+X)]) to “1”.

As such, the generator 42 computes a hash value (h_{k′}(s+X)) using a shared variable X which is shared between the management apparatus 10 and the communication apparatus 12 (one-to-one). Hence, for the same identification information, the generator 42 can set the bit values at different bit positions to “1” every time the shared variable X is changed. Hence, in the present embodiment, false-positive fixation of a Bloom filter to be generated can be suppressed.

The transmitter 36B transmits the generated existence information which is a Bloom filter to the management apparatus 10. The transmitter 36B may directly transmit the existence information to the management apparatus 10 or may transmit the existence information to the management apparatus 10 by multi-hop communication through other communication apparatuses 12.

Note that the transmitter 36B may transmit a destination advertisement object (DAO) including the existence information to the management apparatus 10. In this case, for example, the transmitter 36B may describe the existence information in a DAO in DAO option format and transmit the DAO to the management apparatus 10.

In addition, the transmitter 36B may transmit a DAO including the existence information and the shared variable X used for the generation of a Bloom filter serving as the existence information, to the management apparatus 10.

In addition, the transmitter 36B may transmit a DAO including the existence information and the current location information of the communication apparatus 12 to the management apparatus 10. In this case, the communication apparatus 12 is configured to be provided with a global positioning system (GPS). Then, the transmitter 36B may obtain, from the GPS, current location information of the communication apparatus 12 at the time of transmission of the existence information, and transmit a DAO including the current location information to the management apparatus 10.

Note that the transmitter 36B may separately transmit the existence information to the management apparatus 10, apart from the transmission of a DAO.

Next, the management apparatus 10 will be described.

The management apparatus 10 includes a communicating unit 14, a storage 16, and a controller 18. The communicating unit 14 and the storage 16 are connected to the controller 18.

The communicating unit 14 is a publicly known communication device for performing wireless or wired communication with the plurality of communication apparatuses 12. Note that the communicating unit 14 may be a communication device capable of receiving data and signals wirelessly or by wire from the communication apparatuses 12. The storage 16 stores various types of data.

The controller 18 is a computer configured to include a CPU, etc. Note that the controller 18 may be a circuit other than a CPU, etc.

The controller 18 includes a communication controller 20, a manager 22, a first calculator 24, a second calculator 26, and a constructor 28.

Some or all of the communication controller 20, the manager 22, the first calculator 24, the second calculator 26, and the constructor 28 may be implemented by, for example, causing a processing apparatus such as a CPU to execute a program, i.e., by software, or may be implemented by hardware such as an IC, or may be implemented by using both software and hardware.

The communication controller 20 controls communication with each of the plurality of communication apparatuses 12 through the communicating unit 14. Note that the communication controller 20 may control reception from each of the plurality of communication apparatuses 12.

In the present embodiment, the communication controller 20 has a communication function required for a mesh network. The communication controller 20 uses, for example, publicly known techniques such as RPL.

In the present embodiment, the communication controller 20 functions as a publicly known border router of a mesh network or a root node of an RPL destination-oriented directed acyclic graph (DODAG). In the management apparatus 10, the identification information of each communication apparatus 12 belonging to a mesh network and the communication routes between the communication apparatuses 12 and the management apparatus 10 are identified by the communication controller 20.

A transmitter 20B transmits various types of data and signals to the communication apparatuses 12.

A receiver 20A receives, from each of the plurality of communication apparatuses 12, existence information that probabilistically indicates the characteristics of pieces of identification information of other communication apparatuses 12 detected by each of the plurality of communication apparatuses 12.

In the present embodiment, the receiver 20A receives a DAO including existence information and at least one of a shared variable X and location information, from a communication apparatus 12. Note that the receiver 20A may receive, from a communication apparatus 12, existence information, a shared variable X, and location information, apart from a DAO. Note that the management apparatus 10 may store in advance a shared variable X for each communication apparatus 12. Note also that the management apparatus 10 may store in advance a calculation rule for a shared variable X for each communication apparatus 12 and calculate a shared variable X using the calculation rule.

The receiver 20A stores the received existence information in the storage 16 on a per communication apparatus 12 basis, the communication apparatus 12 being the transmission source of the existence information. For example, the receiver 20A stores, in the storage 16, pieces of existence information received from the respective communication apparatuses 12, in association with pieces of identification information of the communication apparatuses 12 which are the transmission sources of the respective pieces of existence information. Hence, the existence information is managed by the storage 16 on a per communication apparatus 12 basis, the communication apparatus 12 being the transmission source.

The manager 22 generates a basic network structure. In the present embodiment, a DODAG is created as a basic network structure by a publicly known method, using DAOs received from the plurality of communication apparatuses 12. The manager 22 stores the created DODAG in the storage 16.

Meanwhile, the receiver 20A outputs the existence information received from each of the plurality of communication apparatuses 12, to the first calculator 24.

The controller 18 constructs a first calculator 24 and a second calculator 26 for each communication apparatus 12 every time existence information is received from each communication apparatus 12, and allows the first calculator 24 and the second calculator 26 to perform the following processes. Note that the controller 18 may be configured to include a set of a first calculator 24 and a second calculator 26, and perform calculation of a first set (details will be described later) and a second set (details will be described later) which will be described later for each of the plurality of communication apparatuses 12, using the set of the first calculator 24 and the second calculator 26.

The first calculator 24 calculates, for each of the plurality of communication apparatuses 12, at least some of pieces of identification information of the plurality of communication apparatuses 12, as a first set indicating a set of other communication apparatuses 12 detectable by each of the plurality of communication apparatuses 12.

The first calculator 24 calculates, for example, a set of pieces of identification information of at least some communication apparatuses 12 among a plurality of communication apparatuses 12 that can be managed by the first calculator 24, as a first set of communication apparatuses 12 that are likely to be disposed close to each of the plurality of communication apparatuses 12. The term “disposed close to” refers to that each communication apparatus 12 is disposed in a communicable or data receivable area.

Specifically, the first calculator 24 recursively calculates a first set, using hop count c from the management apparatus 10 which is a DAG root in a basic network structure by a DODAG constructed by the manager 22. Note that it is assumed that in the management apparatus 10 (hop count c=0) which is a DAG root, pieces of identification information of other communication apparatuses 12 close to the management apparatus 10 are known.

More specifically, the first calculator 24 calculates, for each of the plurality of communication apparatuses 12, a set of other communication apparatuses 12 provided with the same rank information in an RPL DODAG which is created as a basic network structure, as a first set.

FIG. 3 is a diagram illustrating an example of a DODAG. For example, when a first set for a communication apparatus 12₆ is calculated, the first calculator 24 calculates pieces of identification information of other communication apparatuses 12₄, 12₅, and 12₇ provided with the same rank information as the communication apparatus 12₆, as a first set for the communication apparatus 12₆ (see inside a drawing A in FIG. 3).

In addition, for example, the first calculator 24 may calculate, for each of the plurality of communication apparatuses 12, a set of other communication apparatuses 12 to which are adjacent in a downward route direction other communication apparatuses 12 to which is adjacent in an upward route direction the communication apparatus 12 in a DODAG in RPL which is a routing protocol, among the plurality of communication apparatuses 12, as a first set. Specifically, the first calculator 24 calculates, for each communication apparatus 12, other communication apparatuses 12 which are slave nodes to other communication apparatuses 12 which are master nodes shared between the communication apparatus 12 and the other communication apparatuses, as a first set.

For example, when a first set for the communication apparatus 12₆ is calculated, the first calculator 24 calculates, as a first set for the communication apparatus 12₆, pieces of identification information of other communication apparatuses 12₅ and 12₇ which are slave nodes to each of a communication apparatus 12₂ and a communication apparatus 12₃ which are master nodes of the communication apparatus 12₆ (see inside a diagram B in FIG. 3).

In other words, given that the hop count c of a certain communication apparatus 12 is h (c=h), the first calculator 24 obtains, from the DODAG, other communication apparatuses 12 which are slave nodes to other communication apparatuses 12 (master nodes) having the hop count c=h−1, and calculates the acquired communication apparatuses 12 as a first set for the communication apparatus 12 having the hop count c=h.

Note that, when the receiver 20A receives a DAO including the location information of a communication apparatus 12 which is the transmission source of existence information, the first calculator 24 may calculate a first set by the following method. In addition, the same is also performed for when the receiver 20A receives the location information of each communication apparatus 12 from each communication apparatus 12.

In this case, the first calculator 24 identifies, using the location information of each communication apparatus 12, other communication apparatuses 12 located within a predetermined area from the communication apparatus 12 and calculates, for each communication apparatus 12, pieces of identification information of the identified other communication apparatuses 12, as a first set. For the “predetermined area”, any area may be set in advance.

In addition, the first calculator 24 may store, in the storage 16, in advance the address information of a contractor of each communication apparatus 12. Then, the first calculator 24 may calculate, as a first set, pieces of identification information of other communication apparatuses 12 with address information within a predetermined area from address information associated with identification information of a communication apparatus 12 which is the transmission source of existence information.

Referring back to FIG. 1, based on the existence information received from each of the plurality of communication apparatuses 12 and the first set for each of the plurality of communication apparatuses 12, the second calculator 26 calculates, for each of the plurality of communication apparatuses 12, a second set indicating other communication apparatuses 12 with a smaller number of false positives than the first set, as existence probability information indicating the probability of the existence of a link between each of the plurality of communication apparatuses 12 and each of the other communication apparatuses 12.

The first set calculated by the first calculator 24 is a set calculated by the first calculator 24 irrespective of existence information received from each communication apparatus 12. Hence, the first set for each communication apparatus 12 is highly likely to include other communication apparatuses 12 that are difficult for the communication apparatus 12 to detect. Namely, the first set is a set including identification information of other communication apparatuses 12 with a large number of false positives.

Hence, the second calculator 26 calculates a second set with a smaller number of false positives than the first set, for each communication apparatus 12, using the existence information received from each communication apparatus 12.

In the present embodiment, the second calculator 26 calculates a second set using a Bloom filter serving as existence information.

Here, the Bloom filter is probabilistic information. Hence, when a second set is calculated using only a Bloom filter, false positives cannot be avoided. Specifically, there is a case in which the bit values at bit positions corresponding to k (second number) hash values calculated from identification information of other communication apparatuses 12 that cannot be detected by the communication apparatus 12 are all “1”.

When the saturation of a Bloom filter (the rate of the number of bits with the bit value “1” in the entire number of bits) is Ps, the probability of the occurrence of false positives can be represented by Ps^{k}. k is the number (second number) of hash functions of the Bloom filter.

Hence, when the second calculator 26 calculates a second set using a Bloom filter (existence information) received from each communication apparatus 12, the second set includes other communication apparatuses 12 that are actually undetectable, with a probability of Ps^{k}.

To reduce the probability of the occurrence of false positives Ps^{k} to reduce the number of false positives, the size of a Bloom filter needs to be increased, which is not realistic.

Meanwhile, in the present embodiment, as described above, a Bloom filter received from each communication apparatus 12 is such that the communication apparatus 12 changes, using a shared variable X, the first number of pieces of identification information used for generation of the Bloom filter, the number of bits indicating the data length of existence information, hash functions, and the second number of the hash functions. Hence, it can be said that each Bloom filter received from each communication apparatus 12 is probabilistically an independent trial. Hence, by the second calculator 26 calculating a second set using Bayesian inference from information from a plurality of Bloom filters in the present embodiment, a reduction in the probability of false positives can be achieved.

The second calculator 26 calculates, using a Bloom filter and a shared variable X which are included in a DAO, k hash functions used for the Bloom filter. The second calculator 26 calculates k hash functions in the same manner as the generator 42 of the communication apparatus 12. Then, the second calculator 26 calculates, for each identification information included in a first set, k hash values using each of the k hash functions. Then, the second calculator 26 applies each individual Bloom filter to the first set, using identification information where the bit values at bit positions corresponding to the calculated k hash values are all “1” (i.e., positive) in the Bloom filter, and thereby observes the existence/non-existence of links at different times and calculates a second set. Furthermore, Bayesian inference may be performed on each individual observation information in chronological order and as a result, a second set may be calculated.

More specifically, the second calculator 26 assumes the observed existence probability to be, for example, “1”, for identification information that is positive in a corresponding Bloom filter (i.e., when the bits indicated by k hash functions are all “1”) among pieces of identification information of other communication apparatuses 12 included in the first set. On the other hand, the second calculator 26 assumes the observed existence probability to be any small value, e.g., “0.05”, for identification information that is negative in a corresponding Bloom filter (i.e., when the bits indicated by k hash functions include even a single “0”) among the pieces of identification information of other communication apparatuses 12 included in the first set.

Note that the reason that the existence probability is set to any small value, e.g., “0.05”, instead of “0” for the negative case is to deal with the case in which non-existence of a link is temporary.

In this manner, the second calculator 26 calculates a second set as existence probability information indicating the probability of the existence of links, using existence information (Bloom filter) for each communication apparatus 12.

Note that the second calculator 26 may calculate, for each of the plurality of communication apparatuses 12, a second set (existence probability information) by Bayesian inference based on existence information received from each of the plurality of communication apparatuses 12 and a first set for each of the plurality of communication apparatuses 12.

In a mesh network, in many cases, an adjacent relationship between a plurality of communication apparatuses 12 belonging to the network does not change over time. By assuming that the adjacent relationship between communication apparatuses 12 does not change, the positives and false positives of consecutive, independent Bloom filters which are acquired in chronological order from the communication apparatuses 12 can be considered subjective probability by Bayesian inference, regardless of the probability of the occurrence of false positives.

Specifically, the second calculator 26 calculates, for each of the plurality of communication apparatuses 12, existence probability information using Bayesian inference and utilizing chronological Bloom filters (existence information) of each of the plurality of communication apparatuses 12.

More specifically, whether actual communication apparatuses 12 have an adjacent relationship with each other is an “event that truly needs to be known” (T: True, −T: False). In addition, information acquired from a Bloom filter (a positive or a negative for each identification information) is probabilistic information (P: Positive, −P: Negative). When the probability of each event T is Pγ(T) and the conditional probability of the event T for when an event P occurs is Pγ(T|P), the following Equation (4) holds by Bayes' formula:

$$\begin{matrix}{P}_{r} ( T \vert P ) = \frac{{P}_{r} ( P \vert T ) \cdot {P}_{r} ( T )}{{P}_{r} ( P \vert T ) + {P}_{r} ( P \vert T ) \cdot {P}_{r} ( T )} \\ = \frac{{P}_{r} ( T )}{{P}_{r} ( T ) + {P}_{s}^{K} \cdot ( 1 - {P}_{r} ( T ) )}\end{matrix} \qquad ( 4 )$$

Namely, Pγ(T|P) indicates the probability that each communication apparatus 12 included in a first set is located truly close to a communication apparatus 12 corresponding to the first set (the probability that a link truly exists). Note that the communication apparatus 12 corresponding to the first set is, for example, a central communication apparatus 12 forming the first set.

Here, since Pγ(T) is subjective probability, the second calculator 26 starts Pγ(T) with a predetermined initial value (e.g., 0.5), and updates Pγ(T) every time information by a Bloom filter (a positive or a negative for each identification information) is acquired.

Specifically, the second calculator 26 updates Equation (4) when the bit values at bit positions in a Bloom filter that correspond to the hash values of identification information included in a corresponding first set are all “1” (positive). On the other hand, when at least one of the bit values at bit positions corresponding to the hash values of identification information belonging to a corresponding first set is “0” (negative), another communication apparatus 12 identified by the identification information is determined to have a high probability of not being located near a communication apparatus 12 corresponding to the first set.

Note, however, that there may be a case in which disconnection of a link is temporary or a case in which a link disconnected state recovers due to environmental factors, etc. Hence, when at least one of the bit values at bit positions in a Bloom filter that correspond to the hash values of identification information included in a corresponding first set is “0” (negative), the second calculator 26 sets the expected value of the probability of link restoration to Pγ(T) (e.g., 0.05, etc.).

As such, the second calculator 26 may calculate, using Bayesian inference, existence probability information (second set) indicating the probability of the existence of links, for each communication apparatus 12 and each identification information of other communication apparatuses 12 included in a first set for the communication apparatus 12.

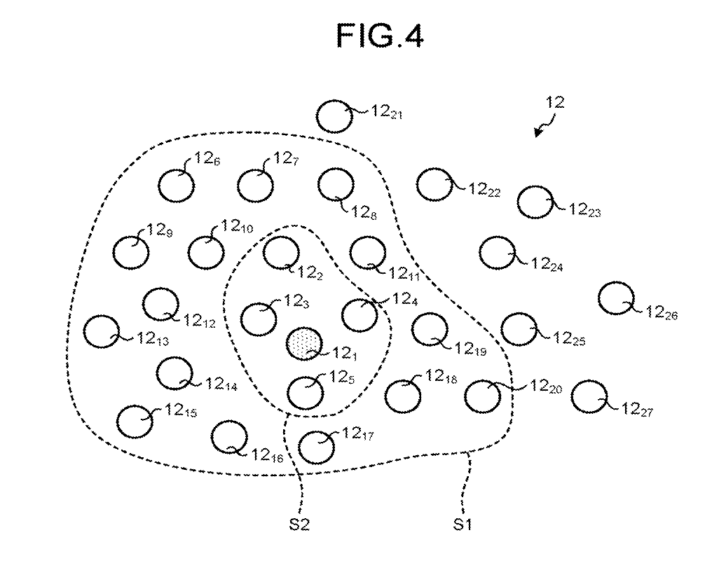

FIG. 4 is a schematic diagram illustrating an example of a relationship between a first set and a second set.

For example, it is assumed that the management apparatus 10 (which is not illustrated in FIG. 4) receives existence information from a communication apparatus 12₁. In this case, the first calculator 24 calculates, as a first set, for example, communication apparatuses 12₆ to 12₂₀ among a plurality of communication apparatuses 12 (communication apparatuses 12₁ to 12₂₇) that can be managed by the management apparatus 10. Then, furthermore, the second calculator 26 calculates a second set (e.g., communication apparatuses 12₂ to 12₅) with a smaller number of false positives than the first set.

Referring back to FIG. 1, the constructor 28 constructs a graph indicating the existence of links between the plurality of communication apparatuses 12, using the existence probability information calculated for each of the plurality of communication apparatuses 12.

For example, the constructor 28 constructs, from existence probability information calculated for each of the plurality of communication apparatuses 12 by the second calculator 26, a graph indicating the existence of links between the communication apparatuses 12. More specifically, there are a case in which existence probability information is used as the weights of links between communication apparatuses 12 (weighted graph) and a case in which only existence probability information greater than or equal to a predetermined threshold value is used as a link.

The graph constructed by the constructor 28 can be used to analyze comparison in stability between different mesh networks, etc.

Note that although the present embodiment describes the case in which the controller 18 is configured to include the constructor 28, the controller 18 may be configured not to include the constructor 28.

Next, a communication process performed by each communication apparatus 12 in the management system 1 will be described.

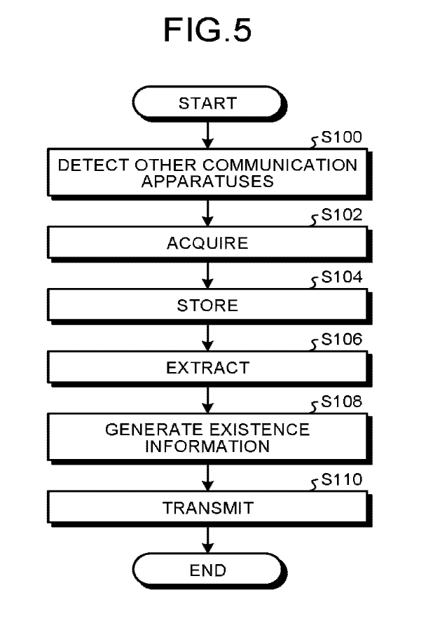

FIG. 5 is a flowchart illustrating an example of a procedure of a communication process performed by the communication apparatus 12.

First, the communication controller 36 detects other communication apparatuses 12 detectable by the communication apparatus 12 (S100). Then, the acquirer 38 obtains, from the detectable other communication apparatuses 12, pieces of identification information of the other communication apparatuses 12 (step S102).

Then, the acquirer 38 stores, in the storage 32, the acquired pieces of identification information of the communication apparatuses 12 and detected dates and times (i.e., received dates and times) of the pieces of identification information in association with each other (step S104).

Then, the extractor 40, the generator 42, and the transmitter 36B perform processes at steps S106 to S110 every predetermined period of time.

First, the extractor 40 extracts at least some of a plurality of pieces of identification information acquired in the past by the acquirer 38 (step S106). Then, the generator 42 generates existence information from the pieces of identification information extracted by the extractor 40 (step S108). Then, the transmitter 36B transmits the generated existence information to the management apparatus 10 (step S110). Then, the routine ends.

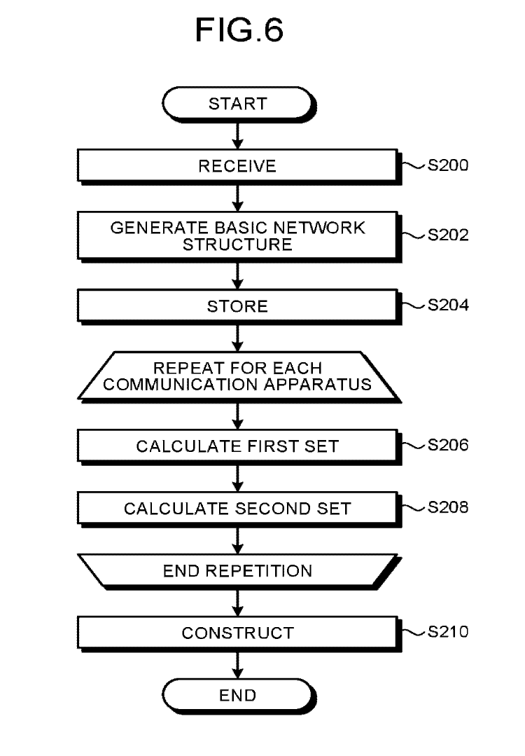

Next, a procedure of a management process performed by the management apparatus 10 will be described. FIG. 6 is a flowchart illustrating a procedure of a management process performed by the management apparatus 10.

First, the receiver 20A receives existence information from each of the plurality of communication apparatuses 12 (step S200). As described above, for example, the receiver 20A receives a DAO including existence information and at least one of a shared variable X and location information of a communication apparatus 12.

Then, the manager 22 generates a basic network structure (e.g., a DODAG) using the DAOs received from the respective plurality of communication apparatuses 12 (step S202). The manager 22 stores the generated basic network structure in the storage 16 (step S204).

Then, the controller 18 repeatedly performs processes at steps S206 to S208 for each communication apparatus 12 whose existence information is received at step S200.

First, the first calculator 24 of the controller 18 calculates a first set for the communication apparatus 12 which is the transmission source of the received existence information (step S206).

Then, the second calculator 26 calculates, using the existence information received from the communication apparatus 12, a second set for the communication apparatus 12 that has a smaller number of false positives than the first set calculated at step S206 (step S208). Then, the second calculator 26 stores, in the storage 16, existence probability information which is the second set calculated at step S208, in association with the identification information of the communication apparatus 12.

The controller 18 performs the processes at steps S206 to S208 for each communication apparatus 12, by which the controller 18 calculates a second set for each communication apparatus 12, as existence probability information for each communication apparatus 12.

Then, the constructor 28 constructs a graph indicating the existence of links between the plurality of communication apparatuses 12, using the existence probability information calculated for each of the plurality of communication apparatuses 12 (step S210). Then, the routine ends. Note that it may be configured not to perform the process at step S210. In this case, the second calculator 26 may store, in the storage 16, existence probability information which is the second set for each communication apparatus 12 calculated at step S208, in association with the identification information of the communication apparatus 12.

As described above, the management apparatus 10 of the present embodiment includes the receiver 20A, the first calculator 24, and the second calculator 26. The receiver 20A receives, from the plurality of communication apparatuses 12, existence information that probabilistically indicates the characteristics of pieces of identification information of other communication apparatuses 12 detected by each of the plurality of communication apparatuses 12. The first calculator 24 calculates, for each of the plurality of communication apparatuses 12, at least some of pieces of identification information of the plurality of communication apparatuses 12, as a first set indicating a set of other communication apparatuses 12 detectable by each of the plurality of communication apparatuses 12. The second calculator 26 calculates, for each of the plurality of communication apparatuses 12, a second set with a smaller number of false positives than the first set, as existence probability information indicating the probability of the existence of a link between each of the plurality of communication apparatuses 12 and each of the other communication apparatuses 12, based on the existence information received from each of the plurality of communication apparatuses 12 and the first set for each of the plurality of communication apparatus 12.

As such, the management apparatus 10 receives, from each of the plurality of communication apparatuses 12, existence information that probabilistically indicates the characteristics of pieces of identification information of other communication apparatuses 12 detected by each of the plurality of communication apparatuses 12. Then, the management apparatus 10 calculates, for each of the plurality of communication apparatuses 12, existence probability information indicating the probability of the existence of a link between each of the plurality of communication apparatuses 12 and each of the other communication apparatuses 12, using the received existence information.

Hence, the management apparatus 10 can obtain information (existence information in the present embodiment) used to calculate existence probability information, with a small amount of data compared to conventional cases.

In addition, the existence probability information calculated for each of the plurality of communication apparatuses 12 is information indicating the probability of the existence of a link between each of the plurality of communication apparatuses 12 and each of other communication apparatuses 12.

Hence, the management apparatus 10 of the present embodiment can provide information (existence probability information) that can also analyze links in directions other than an upward route direction, such as sibling links, which are difficult to be grasped by a DODAG, etc.

Therefore, the management apparatus 10 of the present embodiment can efficiently provide information (i.e., existence probability information) applicable to more accurate network structure analysis.

In addition, by using existence information, the management apparatus 10 of the present embodiment can provide, at low system load, existence probability information of links between communication apparatuses 12 that are not included in a DODAG but may possibly become backups.

In addition, the case is considered in which, in a wireless mesh network, RPL defined in IETF RFC 6550, etc., is used as a routing protocol. In RPL, a topology that connects mesh nodes is a directed acyclic graph (DAG) where a node (border router) connected to a wide area network is a root node. Reversely, RPL does not handle a link that can establish a connection (perform communication or reception) between communication apparatuses 12, but does not form a DAG. On the other hand, when a link forming a DAG becomes unable to be used due to the failure of a communication apparatus 12, etc., each communication apparatus 12 uses the most appropriate one of links that does not form the DAG.

Namely, the number and quality of links that do not form a DAG greatly influence the fault tolerance of a network formed by RPL. Hence, grasping of the number of these links and the locations of the links by the management apparatus 10 is essential for a diagnosis of fault tolerance of a mesh network formed by RPL.

As described above, the management apparatus 10 of the present embodiment receives, from the plurality of communication apparatuses 12, existence information that probabilistically indicates the characteristics of pieces of identification information of other communication apparatuses 12 detected by each of the plurality of communication apparatuses 12. Then, using the received existence information, the management apparatus 10 calculates, for each of the plurality of communication apparatuses 12, existence probability information indicating the probability of the existence of a link between each of the plurality of communication apparatuses 12 and each of the other communication apparatuses 12.

Hence, the management apparatus 10 can provide, with a limited amount of communication, information (existence probability information) that can be used for determination of fault tolerance of a mesh network.

In addition, a Bloom filter serving as existence information which is received from each communication apparatus 12 is generated on the side of the communication apparatus 12, using a shared variable X. Hence, false-positive fixation of a Bloom filter can be suppressed.

In addition, existence information is managed by the storage 16 on a per communication apparatus 12 basis, the communication apparatus 12 being the transmission source of the existence information. Hence, a series of existence information for each communication apparatus 12 provide the management apparatus 10 with pieces of information which are individually independent probabilistic events, due to the effect of the shared variable X.

Then, the second calculator 26 calculates, for each of the plurality of communication apparatuses 12, existence probability information indicating the probability of the existence of a link between each of the plurality of communication apparatuses 12 and each of other communication apparatuses 12, using the existence information for each communication apparatus 12.

Hence, the management apparatus 10 of the present embodiment can efficiently provide information (i.e., existence probability information) applicable to more accurate network structure analysis. In addition, the management apparatus 10 can efficiently provide information (i.e., existence probability information) applicable to more accurate network structure analysis, at minimum system load.

In addition, the constructor 28 constructs a graph indicating the existence of links between the plurality of communication apparatuses 12, using the existence probability information for each communication apparatus 12. Hence, the constructor 28 can construct a graph indicating the existence of links between the plurality of communication apparatuses 12 that can be managed by the management apparatus 10. The constructed graph can be used, for example, for a detailed analysis of the whole image of a network represented by the graph, or quantitative calculation of the health of the network represented by the graph. For the health of the network, an index is considered, e.g., whether there is an unreachable communication apparatus 12 despite the fact that the communication apparatus 12 is not failed, when a failure or the like occurs in some of the plurality of communication apparatuses 12 in a network topology (whether the topology becomes discontinuous), or the worst value for an increase in the radius of a graph when one communication apparatus 12 fails.

### Second Embodiment

The present embodiment describes the case of calculating a first set by a different method than in the first embodiment.

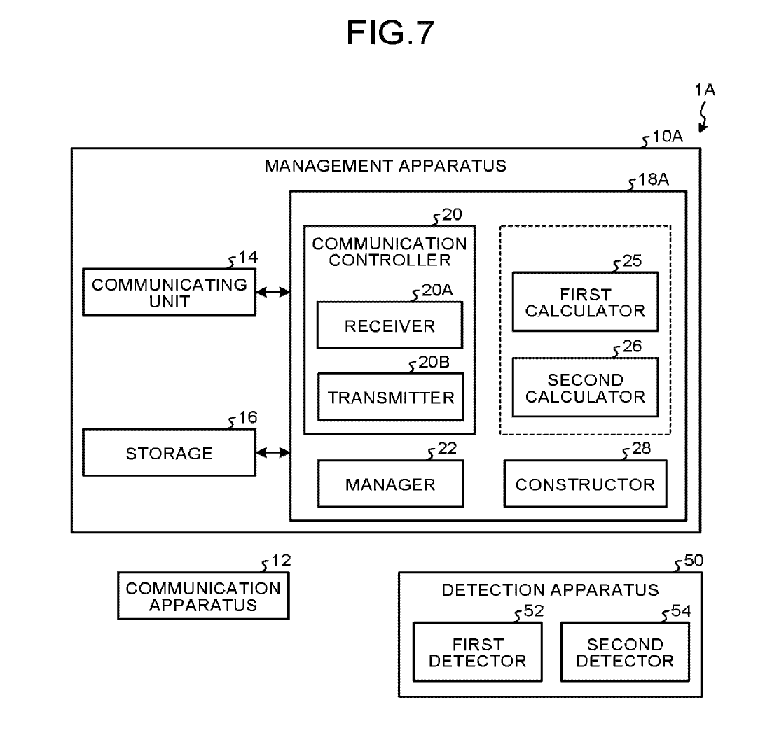

FIG. 7 is a schematic diagram of a management system 1A of the present embodiment. The management system 1A includes a management apparatus 10A, a plurality of communication apparatuses 12, and a detection apparatus 50.

The detection apparatus 50 detects identification information of the communication apparatuses 12. The detection apparatus 50 includes a first detector 52 and a second detector 54.

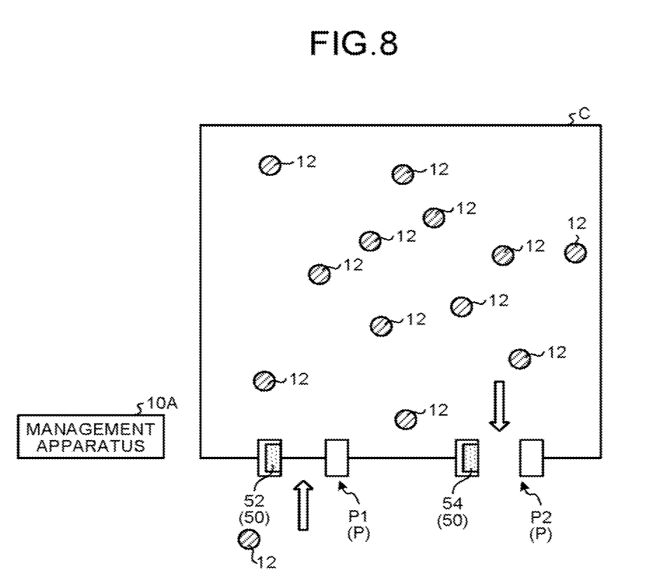

FIG. 8 is an illustrative diagram of the installation location of the detection apparatus 50.

In the present embodiment, the detection apparatus 50 is installed at an entrance/exit P of a predetermined region C in real space. The region C is, for example, a specific room, a store, or a warehouse. The detection apparatus 50 detects identification information of each communication apparatus 12 that enters the region C through the entrance/exit P and each communication apparatus 12 that gets out of the region C through the entrance/exit P. The present embodiment assumes the case in which each communication apparatus 12 is carried by a mobile unit such as a person, and moves with the movement of the mobile unit.

For the detection apparatus 50, a publicly known apparatus capable of detecting identification information of the communication apparatuses 12 is used. It is assumed, for example, that the surface of each communication apparatus 12 is provided with an image (e.g., a barcode) indicating identification information. In this case, as the detection apparatus 50, a publicly known image reading apparatus may be used. In addition, when identification information which is stored as electronic data in a communication apparatus 12 is detected, for the detection apparatus 50, a publicly known detection apparatus may be used that detects the identification information by transmitting an identification information transmit request to the communication apparatus 12 and reading identification information included in a reply received from the communication apparatus 12.

In the present embodiment, the region C is provided with an entrance portion P1 and an exit portion P2 as the entrance/exit P. The case will be described in which the first detector 52 is disposed at the entrance portion P1, and the second detector 54 is disposed at the exit portion P2.

Hence, the first detector 52 detects identification information of a communication apparatus 12 entering the region C. Then, every time the first detector 52 detects identification information, the first detector 52 transmits a detection result including the detected identification information to the management apparatus 10A.

The second detector 54 detects identification information of a communication apparatus 12 getting out of the region C. Then, every time the second detector 54 detects identification information, the second detector 54 transmits a detection result including the detected identification information to the management apparatus 10A.

Referring back to FIG. 7, the communication apparatuses 12 are the same as those of the first embodiment. The management apparatus 10A and each of the plurality of communication apparatuses 12 can perform communication with each other by communicating units (a communicating unit 14 and a communicating unit 30). The management apparatus 10A and each of the plurality of communication apparatuses 12 may be able to perform direct communication with each other or may be able to perform relay communication (multi-hop communication) with each other. Communication between the management apparatus 10A and each of the communication apparatuses 12 can use publicly known techniques such as TCP/IP, 6LoWPAN, RPL, and 802.15.4.

The management apparatus 10A includes the communicating unit 14, a storage 16, and a controller 18A. The communicating unit 14 and the storage 16 are connected to the controller 18A.

The communicating unit 14 and the storage 16 are the same as those of the first embodiment. The controller 18A includes a communication controller 20, a manager 22, a first calculator 25, a second calculator 26, and a constructor 28.

Some or all of the communication controller 20, the manager 22, the first calculator 25, the second calculator 26, and the constructor 28 may be implemented by, for example, causing a processing apparatus such as a CPU to execute a program, i.e., by software, or may be implemented by hardware such as an IC, or may be implemented by using both software and hardware.

The communication controller 20, the manager 22, the second calculator 26, and the constructor 28 are the same as those of the first embodiment. Note that the communication controller 20 receives a detection result from the detection apparatus 50 through the communicating unit 14. The detection result includes identification information of a communication apparatus 12 detected by the detection apparatus 50.

The first calculator 25 calculates, as a first set, pieces of identification information of communication apparatuses 12 detected by the detection apparatus 50 which is installed at the entrance/exit P of the predetermined region C, among the plurality of communication apparatuses 12.

In addition, it is preferred that the first calculator 25 calculate, as a first set, pieces of identification information of communication apparatuses 12 remaining after excluding communication apparatuses 12 detected by the second detector 54 provided at the exit portion P2 of the predetermined region C, from communication apparatuses 12 detected by the first detector 52 provided at the entrance portion P1 of the region C, among the plurality of communication apparatuses 12.

Hence, the first calculator 25 calculates, as a first set, pieces of identification information of communication apparatuses 12 existing in the region C.

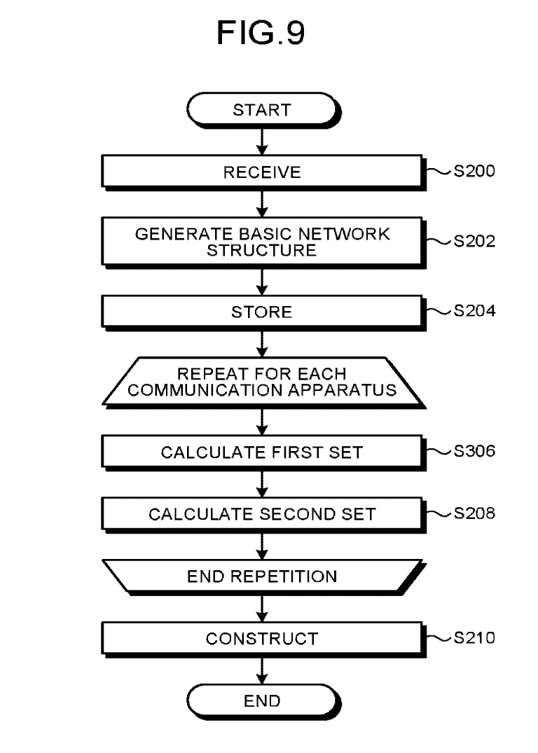

Next, a procedure of a management process performed by the management apparatus 10A will be described. FIG. 9 is a flowchart illustrating a procedure of a management process performed by the management apparatus 10A. Note that the same processes as those of a management apparatus 10 of the first embodiment are denoted by the same step numbers and a detailed description thereof is omitted.

First, a receiver 20A receives existence information from each of the plurality of communication apparatuses 12 (step S200). Then, the manager 22 generates a basic network structure, using a DAO received from each of the plurality of communication apparatuses 12 (step S202). The manager 22 stores the generated basic network structure in the storage 16 (step S204).

Then, the controller 18A repeatedly performs processes at steps S306 and S208 for each communication apparatus 12 whose existence information is received at step S200.

First, the first calculator 25 of the controller 18A calculates a first set for the communication apparatus 12 which is the transmission source of the received existence information (step S306). In the present embodiment, the first calculator 25 calculates, as a first set, pieces of identification information remaining after excluding pieces of identification information included in detection results received from the second detector 54 from pieces of identification information included in detection results received from the first detector 52 upon or immediately before the process at step S306.

Specifically, when the first calculator 25 receives a detection result from the first detector 52, the first calculator 25 stores, in the storage 16, identification information included in the detection result. In addition, when the first calculator 25 receives a detection result from the second detector 54, the first calculator 25 deletes identification information included in the detection result, from the storage 16. Then, upon calculation of a first set at step S306, the first calculator 25 reads, as a first set, pieces of identification information stored in the storage 16 and thereby calculates the first set.

Then, the second calculator 26 calculates, using existence information received from the communication apparatus 12, a second set for the communication apparatus 12 that has a smaller number of false positives than the first set calculated at step S306 (step S208). Then, the second calculator 26 stores, in the storage 16, existence probability information which is the second set calculated at step S208, in association with the identification information of the communication apparatus 12.

Then, the constructor 28 constructs a graph indicating the existence of links between the plurality of communication apparatuses 12, using the existence probability information calculated for each of the plurality of communication apparatuses 12 (step S210). Then, the routine ends. Note that, as with the first embodiment, it may be configured not to perform the process at step S210.

As described above, the management apparatus 10A of the present embodiment includes the first calculator 25 instead of a first calculator 24 of the first embodiment. The first calculator 25 calculates, as a first set, pieces of identification information of communication apparatuses 12 detected by the detection apparatus 50 which is installed at the entrance/exit P of the region C, among the plurality of communication apparatuses 12.

Hence, in addition to the effects obtained in the above-described first embodiment, the management apparatus 10A of the present embodiment can further calculate existence probability information for each of the plurality of communication apparatuses 12, using pieces of identification information of communication apparatuses 12 that are likely to exist within a specific region.

### Third Embodiment

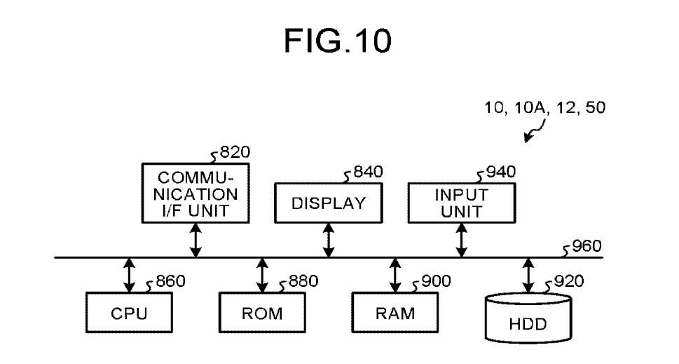

Next, a hardware configuration of a management apparatus 10, a management apparatus 10A, a communication apparatus 12, and a detection apparatus 50 of the above-described embodiments will be described. FIG. 10 is a block diagram illustrating an exemplary hardware configuration of a management apparatus 10, a management apparatus 10A, a communication apparatus 12, and a detection apparatus 50 of the above-described embodiments.

The management apparatus 10, the management apparatus 10A, the communication apparatus 12, and the detection apparatus 50 of the above-described embodiments have a hardware configuration using a normal computer where a communication I/F unit 820, a display 840, an input unit 940, a CPU 860, a read only memory (ROM) 880, a random access memory (RAM) 900, an HDD 920, etc., are connected to each other by a bus 960.

The CPU 860 is an arithmetic unit. The RAM 900 stores data required for various types of processes performed by the CPU 860. The ROM 880 stores a program for implementing various types of processes performed by the CPU 860, etc. The HDD 920 stores data stored in the above-described storage 16 and storage 32, etc. The communication I/F unit 820 is an interface that establishes a connection with another apparatus through a communication line, etc., to perform data reception or communication (transmission and reception) with the connected apparatus. The display 840 displays various types of images, etc. The input unit 940 is operated by a user when various types of instructions are inputted.

A program for performing the above-described various types of processes which are performed by the management apparatus 10, the management apparatus 10A, the communication apparatus 12, and the detection apparatus 50 of the above-described embodiments is provided by being pre-installed in the ROM 880 or the like.

Note that the program executed by the management apparatus 10, the management apparatus 10A, the communication apparatus 12, and the detection apparatus 50 of the above-described embodiments may be configured to be provided by being recorded in a file in a format installable or executable by these apparatuses, in a computer readable recording medium such as a CD-ROM, a flexible disk (FD), a CD-R, or a digital versatile disk (DVD), which may be provided as a computer program product.

In addition, the program executed by the management apparatus 10, the management apparatus 10A, the communication apparatus 12, and the detection apparatus 50 of the above-described embodiments may be configured to be provided by being stored on a computer connected to a network such as the Internet, and downloaded via the network. In addition, the program executed by the management apparatus 10, the management apparatus 10A, the communication apparatus 12, and the detection apparatus 50 of the above-described embodiments may be configured to be provided or distributed via a network such as the Internet.

The program executed by the management apparatus 10, the management apparatus 10A, the communication apparatus 12, and the detection apparatus 50 of the above-described embodiments is configured to generate the above-described units on a main storage apparatus.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A management apparatus comprising:
a receiver configured to receive pieces of existence information from a plurality of communication apparatuses, respectively, each piece of existence information probabilistically indicating characteristics of pieces of identification information of other communication apparatuses detected by a corresponding communication apparatus;
a first calculator configured to calculate, for each of the plurality of communication apparatuses, at least one of the pieces of identification information, as a first set indicating a set of other communication apparatuses detectable by the each of the plurality of communication apparatuses; and
a second calculator configured to calculate, for each of the plurality of communication apparatuses, a second set with a smaller number of false positives than the corresponding first set, as a piece of existence probability information, based on the piece of existence information received from the each of the plurality of communication apparatuses and the corresponding first set, the piece of existence probability information indicating a probability of existence of a link between the each of the plurality of communication apparatuses and each of the other communication apparatuses.

2. The management apparatus according to claim 1, wherein the piece of existence information is a Bloom filter representing the characteristics of the pieces of identification information of other communication apparatuses detected by the each of the plurality of communication apparatuses, by a bit pattern with bit positions corresponding to hash values of the pieces of identification information.

3. The management apparatus according to claim 2, wherein the second calculator calculates, for each of the plurality of communication apparatuses, the second set based on a bit value at a bit position corresponding to a hash value of each piece of identification information of the communication apparatuses included in the corresponding first set, in the Bloom filter.

4. The management apparatus according to claim 1, wherein the second calculator calculates the second set by Bayesian inference based on the corresponding piece of existence information and the corresponding first set.

5. The management apparatus according to claim 1, wherein the first calculator calculates, as the first set, a set of other communication apparatuses among the plurality of communication apparatuses, the other communication apparatuses being provided with a same rank information as the each of the communication apparatuses in a destination-oriented directed acyclic graph in IPv6 Routing Protocol for Low power and Lossy Networks (RPL) serving as a routing protocol.

6. The management apparatus according to claim 1, wherein the first calculator calculates, as the first set, a set of other communication apparatuses which are adjacent in a downward route direction from other communication apparatuses which are adjacent in an upward route direction in a destination-oriented directed acyclic graph in RPL serving as a routing protocol, among the plurality of communication apparatuses.

7. The management apparatus according to claim 1, wherein
the receiver receives each piece of existence information and a piece of location information of the communication apparatus being a transmission source of the each piece of existence information, and
the first calculator calculates, as the first set, pieces of identification information of other communication apparatuses located within a predetermined area from the each of the communication apparatuses.

8. The management apparatus according to claim 1, wherein the first calculator calculates, as the first set, pieces of identification information of the communication apparatuses detected by a detector installed at an entrance/exit of a predetermined region, among the plurality of communication apparatuses.

9. The management apparatus according to claim 1, wherein the first calculator calculates, as the first set, pieces of identification information of the communication apparatuses remaining after excluding the communication apparatuses detected by a second detector, from the communication apparatuses detected by a first detector among the plurality of communication apparatuses, the first detector being provided at an entrance portion of a predetermined region, the second detector being provided at an exit portion of the region.

10. The management apparatus according to claim 1, wherein the receiver receives a destination advertisement object (DAO) including the corresponding piece of existence information from each of the plurality of communication apparatuses.

11. The management apparatus according to claim 1, further comprising a constructor configured to construct a graph indicating existence of links between the plurality of communication apparatuses, using the pieces of existence probability information.

12. The management apparatus according to claim 1, wherein the receiver receives the pieces of existence information from the plurality of communication apparatuses, each piece of existence information indicating, in a predetermined fixed length, the characteristics of pieces of identification information of other communication apparatuses detected by the each of the plurality of communication apparatuses.

13. The management apparatus according to claim 1, wherein the receiver receives the pieces of existence information from the plurality of communication apparatuses, each piece of existence information indicating, in a variable length, the characteristics of pieces of identification information of other communication apparatuses detected by the each of the plurality of communication apparatuses.

14. A communication apparatus comprising:
an acquirer configured to acquire, from detectable other communication apparatuses, pieces of identification information of the other communication apparatuses;
a generator configured to generate existence information indicating, in a predetermined fixed length, characteristics of the pieces of identification information; and
a transmitter configured to transmit the existence information to a management apparatus.

15. The communication apparatus according to claim 14, further comprising an extractor configured to extract at least one of the pieces of identification information acquired in past, wherein
the generator generates the existence information indicating, in a predetermined fixed length, characteristics of the extracted pieces of identification information.

16. The communication apparatus according to claim 14, wherein the existence information is a Bloom filter representing the characteristics of the pieces of identification information, by a bit pattern with bit positions corresponding to hash values of the pieces of identification information.

17. The communication apparatus according to claim 14, wherein
the generator
calculates a first number of the pieces of identification information used to generate the existence information, a number of bits indicating a data length of the existence information, a hash function, and a second number of the hash function, and
generates the existence information using the pieces of identification information whose number is the first number among the acquired pieces of identification information, the number of bits, and the hash function whose number is the second number.

18. A management system comprising:
a plurality of communication apparatuses; and
a management apparatus, wherein
each of the plurality of communication apparatuses includes
an acquirer configured to acquire, from detectable other communication apparatuses, pieces of identification information of the other communication apparatuses;
a generator configured to generate a piece of existence information indicating, in a predetermined fixed length, characteristics of the pieces of identification information; and
a transmitter configured to transmit the piece of existence information to the management apparatus, and
the management apparatus includes
a receiver configured to receive the pieces of existence information from the plurality of communication apparatuses, respectively;
a first calculator configured to calculate, for each of the plurality of communication apparatuses, at least one of the pieces of identification information, as a first set indicating a set of other communication apparatuses detectable by the each of the plurality of communication apparatuses; and
a second calculator configured to calculate, for each of the plurality of communication apparatuses, a second set with a smaller number of false positives than the corresponding first set, as a piece of existence probability information, based on the piece of existence information received from the each of the plurality of communication apparatuses and the corresponding first set, the piece of existence probability information indicating a probability of existence of a link between the each of the plurality of communication apparatuses and each of the other communication apparatuses.

19. A management method comprising:
receiving pieces of existence information from a plurality of communication apparatuses, respectively, each piece of existence information probabilistically indicating characteristics of pieces of identification information of other communication apparatuses detected by a corresponding communication apparatus;
calculating, for each of the plurality of communication apparatuses, at least one of the pieces of identification information, as a first set indicating a set of other communication apparatuses detectable by the each of the plurality of communication apparatuses; and
calculating, for each of the plurality of communication apparatuses, a second set with a smaller number of false positives than the corresponding first set, as a piece of existence probability information, based on the piece of existence information received from the each of the plurality of communication apparatuses and the corresponding first set, the piece of existence probability information indicating a probability of existence of a link between the each of the plurality of communication apparatuses and each of the other communication apparatuses.

20. A computer program product comprising a computer-readable medium containing a program executed by a computer, the program causing the computer to execute:
receiving pieces of existence information from a plurality of communication apparatuses, respectively, each piece of existence information probabilistically indicating characteristics of pieces of identification information of other communication apparatuses detected by a corresponding communication apparatus;
calculating, for each of the plurality of communication apparatuses, at least one of the pieces of identification information, as a first set indicating a set of other communication apparatuses detectable by the each of the plurality of communication apparatuses; and
calculating, for each of the plurality of communication apparatuses, a second set with a smaller number of false positives than the corresponding first set, as a piece of existence probability information, based on the piece of existence information received from the each of the plurality of communication apparatuses and the corresponding first set, the piece of existence probability information indicating a probability of existence of a link between the each of the plurality of communication apparatuses and each of the other communication apparatuses.
